(19) United States
(12) Patent Application Publication
(10) Pub. No.: US 2017/0110862 A1
(43) Pub. Date: Apr. 20, 2017

(54) Electrical Face Plates with Magnets and Associated Methods

(71) Applicant: Frank Stuart Kirkland, III, Winston-Salem, NC (US)

(72) Inventor: Frank Stuart Kirkland, III, Winston-Salem, NC (US)

(21) Appl. No.: 14/882,848

(22) Filed: Oct. 14, 2015

(51) Int. Cl. H02G 3/08; H02G 3/14; H01H 11/00; H01F 7/02; H01R 43/26

(52) U.S. Cl. CPC H02G 3/081; H01F 7/021; H01R 43/26; H01H 11/00; H02G 3/14

(57) ABSTRACT

Face plates that have magnets in them and at least one opening that is designed to accommodate outlet receptacles or light switch receptacles are disclosed. The face plate is attached to the receptacle and/or an outlet or light switch mounting box by magnetism wherein the magnets that are associated with the face plate attach by magnetism to metal that is present on the receptacles or mounting box. The magnets that are associated with the face plate may be attached to the face plate by adhesive, or the magnets may be integrally molded during manufacture of the face plate, or the magnets may snap fit into cavities that are present on the face plate.

### FIELD OF THE INVENTION

The present invention relates to electric light switch face plates and outlet face/wall plates that have magnets attached to them as a means of connecting the faceplates to electric and light switch receptacles and or mounting boxes. The electric light switch and outlet face/wall plates have at least one hole in them that is able to accommodate the light switch and/or electric outlets so that they can be used for normal operation.

### BACKGROUND OF THE INVENTION

Although many believe that Ben Franklin was the first discoverer of electricity, this notion is incorrect. The Egyptians were aware of electric fish at least around 2750 BC (when the first Hieroglyphics writings about these fish appeared). Later, the Greeks were aware of magnetism, and were aware that electric shocks could be delivered by static electricity, and were further aware that by rubbing amber rods on cat fur, the rod was able to attract feathers. Thales of Miletus believed incorrectly that the attraction of the feathers to the amber rods were due to magnetism (although later it was shown that there was in fact a link between magnetism and electricity). The Greeks and others were aware of lightning strikes and thought that lightning might be electricity. In the 1600s, Otto Von Guericke made observations on static electricity when he generated his sulfur ball. Franklin confirmed that lightning was in fact electricity when he performed his famous kite experiment. Franklin also postulated that the Leydan jar stored large amounts of electrical charge in it.

At the turn of the 18^{th} century, Luigi Galvani and Allasandro Volta both made important contributions to the electrical sciences by postulating that electricity was the means by which nerve cells operate and by construction of the first batteries, respectively.

Throughout the 19^{th} and 20^{th} century, a number of inventors made important contributions to the electrical field including Thomas Edison who invented the incandescent light bulb. In the late 19^{th} century, electricity was first introduced into houses for lights. Around 1883, T. T. Smith introduced the first outlet into homes. By 1889, the British General Electric Company had a catalogue that contained outlets that could be purchased. In 1995, the founder of the General Electric Company Ltd, Gustav Binswanger, patented a plug and socket using a concentric (co-axial) contact system. Harvey Hubbell obtained patents in the United States in the early 20^{th} century for early American 2 pin plugs and adaptors. At the time, the plugs were plugged into receptors that would hold lamps. Eventually, however, the wall sockets that are still in use today were developed.

Presently, electricity in the developed world is generated by large electricity generating plants using coal, natural gas, water, solar or wind and delivered to households. Electricity may be generated on a more local level by one of these sources (for example, for households that are “off the grid”). When electricity is generated at large electricity generating plants, the current is sent to transformers that increase the voltage to allow power to travel long distances. Generally, after transmission of the power, the electricity is usually sent to substations that reduce the voltage and prepare the electricity to be delivered to neighborhoods where even smaller transformers (for example, at the tops of electrical poles) may further reduce the voltage for delivery though a service drop (and a meter) to houses. The electricity goes to the service panel where there are fuses that protect the wires that go to lights, outlets, etc. in houses from being overload by currents that are too high. Electricity is delivered as needed for lights, appliances, etc. when light switches are turned on or products are plugged into outlets.

To prevent electrical shock, light switches and electrical outlet receptacles contain face plates that protect an electricity user from touching wires and electrical boxes that may be electrically charged. The currently available means of attaching a face plate to a light switch or an outlet receptacle is by use of one or more screws that allows attachment of the face plate to one or more screw holes in the outlet plug and/or light switch receptacle or mounting box. It should be recognized that any time one wants to attach or remove the face plate, a screwdriver is necessary. Furthermore, one has to make sure that one does not lose the one or more screws that are necessary to attach the face plates.

Moreover, in commercial construction in buildings, a building may have a plethora of face plates that need to be attached to outlet plugs/light switch receptacles. For large buildings, the number of face plates may number in the thousands. Assuming one has a thousand face plates that need to be added and secured, and assuming that each face plate takes 30 seconds to secure it to the outlet or light switch receptacle means that more than one work day will be needed to add and secure the face plates. However, if one were to reduce the amount of time it takes to add and secure a face plate to five seconds, the amount of time it would take to add and secure face plates to one thousand outlet and light switch receptacles would be less than an hour and a half.

The present invention was developed to address these issues and/or shortcomings of the prior art.

### BRIEF SUMMARY OF THE INVENTION

The present invention relates to electric light switch face plate and outlet face/wall Plates that have one or more magnets attached to them as a means of connecting the plates to electric outlet and light switch outlet receptacles and/or outlet boxes. The one or more magnets are positioned correctly so that they can attach (via magnetism) to metal parts in the electric and light switch outlet receptacles. The electric light switch and outlet face/wall plates have at least one hole in them that is able to accommodate the light switch and/or electric outlet receptacles (outlet plugs) so that they can be used for normal operation. Because screws are unnecessary to attach the faceplates, the face plates of the current invention do not have holes in the face plates for the one or more screws (as is required by the face plates of the prior art) Thus, the present invention is not just directed to the face plates containing magnets and one or more appropriate holes to accommodate the light switch and/or outlets, but it is also directed to methods associated therewith, for example a method of more rapidly allowing the attachment and/or removal of face plates.

### BRIEF DESCRIPTION OF THE SEVERAL VIEWS OF THE DRAWINGS

FIG. 1 shows the back side view of a face plate that is designed to fit over an electrical outlet receptacle.

FIG. 2 shows the front side view of a face plate that is designed to fit over an electrical outlet receptacle.

FIG. 3 shows a side view of as face plate that is designed to fit over an electrical outlet receptacle.

FIG. 4 shows a front view of an electric mounting box containing a plug outlet receptacle.

FIG. 5 shows how the back side of a face plate with magnets attaches to an electric outlet receptacle.

FIG. 6 shows the back side view of a face plate that is designed to it over a light switch receptacle.

FIG. 7 shows the front side view of a face plate that is designed to fit over a light switch receptacle.

FIG. 8 shows a side view of a face plate that is designed to fit over a light switch receptacle.

FIG. 9 shows a front view of an electric mounting (outlet) box containing a light switch receptacle.

FIG. 10 shows how the face plate with magnets fits on an electric outlet box containing a light switch receptacle.

### DETAILED DESCRIPTION OF THE INVENTION

The present invention relates to electric light switch and outlet face/wall plates that have one or more magnets attached to them as a means of connecting the face plates to electric and light switch outlet receptacles or mounting boxes. The one or more magnets are positioned correctly so that they can attach (via magnetism) to metal parts in the electric and light switch receptacles. The electric light switch and outlet face/wall plates have at least one hole in them that is able to accommodate the light switch and/or electric receptacles so that they can be used for normal operation. Because screws are unnecessary to attach the face plates, the face plates of the current invention do not have holes in the face plates for the one or more screws (as is required by the face plates of the prior art) Thus, the present invention is not just directed to the face plates containing magnets and one or more appropriate holes (openings) to accommodate the light switch and/or outlet receptacles, but it is also directed to methods associated therewith, for example a method of more rapidly allowing the attachment and/or removal of face plates.

Often, outlet plug receptacles and light switch receptacles contain both plastic and metal parts. The plastic part of receptacles that accommodates plugs and the light switch lever both tend to be made of plastic (such as nylon) and tend to be raised a little hit from the plane of the rest of the outlet plug/light switch receptacle. Having these parts raised from the plane of the light switch/outlet receptacle allows them to fit exactly into the openings present in the face plate, which gives the combined face plate and outlet box/light switch receptacles and the mounting box (which is not seen) a more aesthetic appearance.

Although, the face plates of the present invention have a more aesthetic appearance than those of the prior art, it should also be understood that the face plates of the present invention are designed to be functional so that the light switch and outlets work and are not simply decorative. In this manner, the light switch and outlets are useable and functional when the face plate is attached. Stated differently, the outlet plugs and the light switch lever is accessible to a user when the face plate is in position (i.e., attached) so that they can be used.

The invention will be described with reference to the figures. It should be understood that the figures are meant to be examples of the invention and are thus, not supposed to limit the invention. Rather, those of skill in the art will recognize that modifications can be made to the invention without departing from the spirit and scope of the invention.

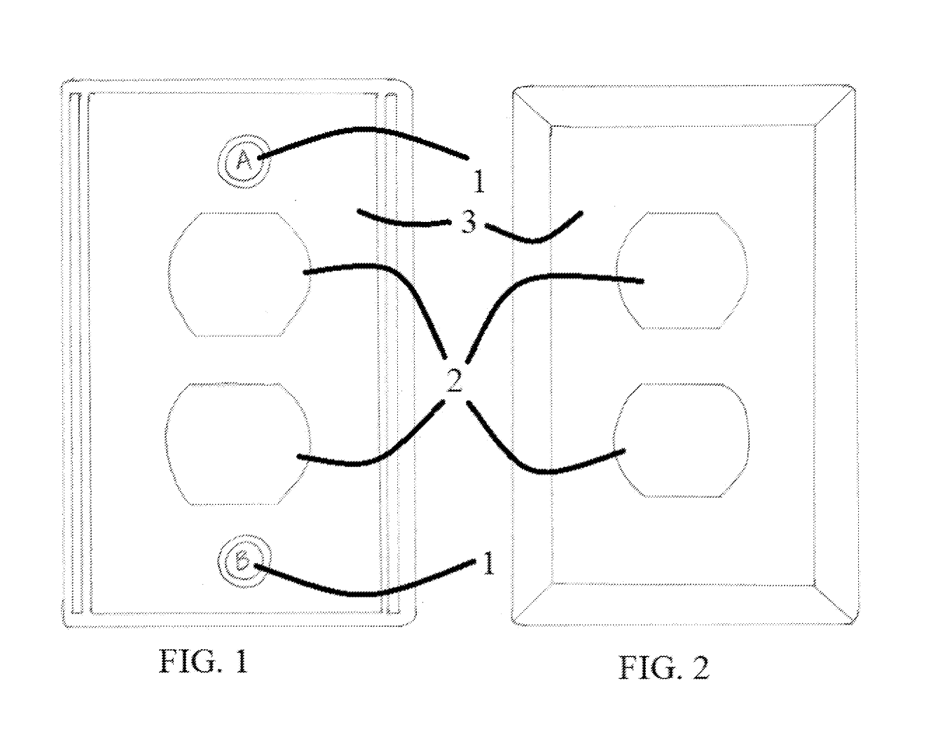

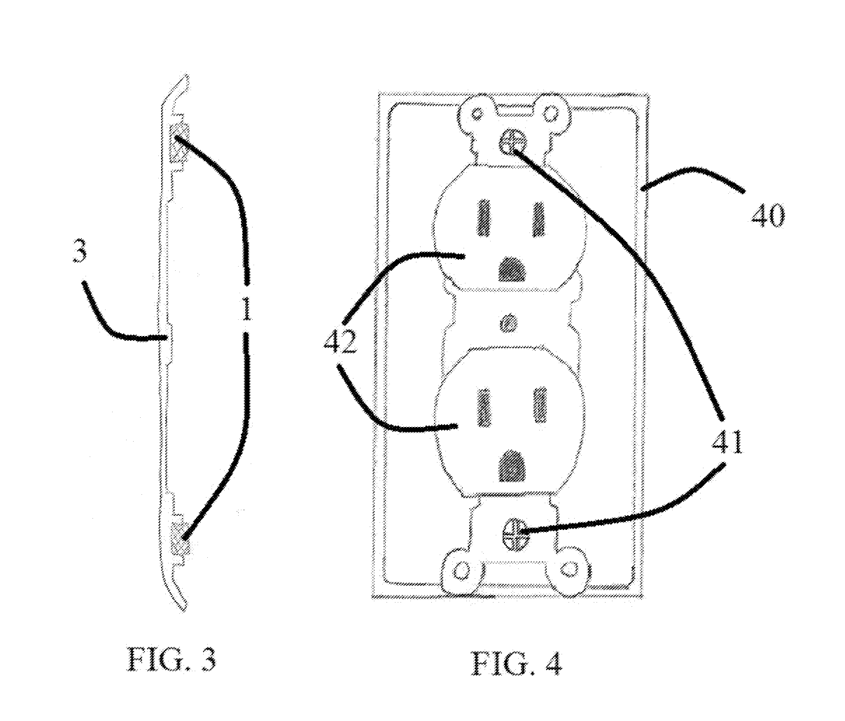

FIG. 1 shows the back side view of a face plate 3 that is designed to fit over an electrical outlet receptacle and mounting box. The back side of the face plate is designed to face the wall and not be visible when the face plate is in place over an electric outlet receptacle and mounting box. As can be seen in FIG. 1, there appear two openings 2 (holes) that are designed to accommodate the corresponding outlets that appears on the receptacle in a mounting box. Magnets 1 are attached to the face plate 3 as shown in FIG. 1. It should be noted that the position of magnets 1 are designed so as to allow the magnets to attach to a metal part on the outlet receptacle or electric outlet mounting box (best seen in FIG. 4). The magnets 1 should be of sufficient strength that allows the magnets to attach and hold the face plate in position but not so strong as to affect the electric current that is delivered by the outlets. Because magnets have a magnetic field, they are also known to have an electrical field associated with this magnetic field. Accordingly, if the magnetic field is too strong, the corresponding electric field might adversely affect the current that is delivered by the outlets. It has been found that the magnetic field must be very strong to adversely affect the electricity from the outlets.

The magnets 1 may be attached to the face plate 3 by any of a plurality of mechanisms including using adhesives and/or manufacturing the magnets so that they are present in place when the face plate is manufactured. If an adhesive is used, the adhesive may be a reactive or non-reactive adhesive. In an embodiment, the adhesive may be either a solvent based adhesive or polymer dispersion adhesives (an emulsion adhesive) or a combination of the two. The adhesive may be one or more of various types of glue, such as a pressure sensitive adhesive, or as heat sensitive adhesive. Alternatively and or additionally, the adhesive may be an animal protein based adhesive such as albumin glues, casein glues, or meat glues. The adhesive may be a plant based glue such as Canada balsam, Coccoina, gum Arabic, a latex based glue, a starch based glue, a methyl cellulose based glue, a mucilage based glue, a resorcinol resin, or a urea-formaldehyde based glue. Alternatively and/or additionally, the adhesive may be a polystyrene cement/butanone, or a dichloromethane based adhesive. Alternatively and/or additionally, the adhesive may be an acrylonitrile based glue, cyanoacrylate based glue, an acrylic based monomer glue, or a resorcinol based glue. Alternatively and/or additionally, the adhesive may be an epoxy resin, an epoxy putty, an ethylene-vinyl acetate based glue (hot melt glue), a phenol formaldehyde based glue, a poly amide based glue, a polyester resin based adhesive, a polypropylene based glue, a polysulfide based glue, a polyurethane based glue, a polyvinyl acetate based glue, a polyvinyl alcohol based glue, polyvinyl chloride based glue, a polyvinylpyrrolidone based glue, a rubber cement, a silicone based glue, an acrylic copolymer, a styrene acrylic copolymer based glue, a styrene-butadiene-styrene, as styrene-isoprene-styrene, and/or a silicone polymer based glue.

Examples of magnets that can be used in the present invention are magnets that are made of alloys such as those made from iron and nickel. Generally, by heating a ferromagnetic alloy to its Curie point, one can align the various magnetic domains so that they are all substantially aligned so as to create relatively strong magnetic fields. It is preferred that the magnets that are used in the present invention be of relatively strong magnetic field so that they are capable of being able to tightly hind the outlet box. Neodymium, Neodymium Iron Boron, Alnico (aluminum, nickel and cobalt alloy), samarium cobalt, or ceramic magnets may be used in one embodiment of the invention. In one embodiment, flexible magnets may be used. In a variation, if flexible magnets are used, they may be in the form of strips (sheet-like) that an able to be inserted into the face plate without affecting current and interfering with the openings that are present in the face plates. In one variation, if a flexible magnet is used, it may cut so that it occupies the entire area of the face plate but with holes in it where the openings occur.

If the magnets are incorporated during the manufacturing process of the face plate, they may be integrally molded so that they are positioned as shown in FIG. 1. Alternatively, the magnets may be of a size that they are able to snap fit into cavities that are designed to hold the magnets after manufacture of the face plates.

FIG. 2 shows the front side view of a face plate 3 that is designed to fit over an electrical outlet receptacle and/or mounting box. The front side of the face plate is the side of the face plate that is visible when the face plate is in place over an electric outlet receptacle and mounting box. It should be noted that there appear two openings 2 (holes) that are designed to accommodate the corresponding outlet receptacle that appears in a mounting box. Also, it should be apparent by observing FIG. 2 that there are no holes that are present for screws. Thus, the front side of the Face plate has a more aesthetic appearance that is not diminished by the presence of one or more screw holes.

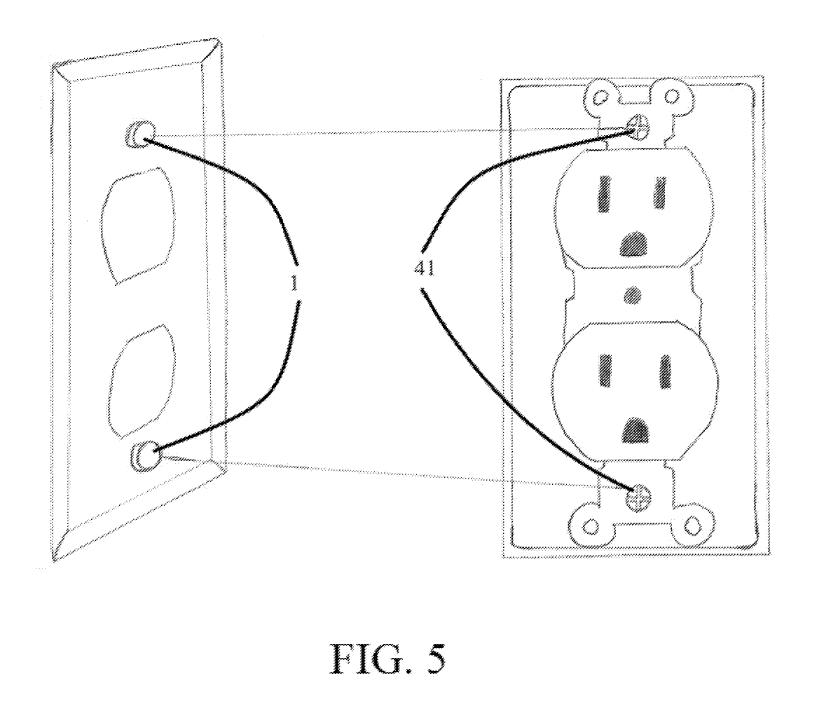

FIG. 3 shows a side view of as face plate 3 that is designed to fit over an electrical outlet mounting box 40 as shown in, for example, FIG. 4. The magnets 1 correspondingly are positioned so that they can be attached where screw holes 41 are on the electric outlet mounting box 40. It should be noted that each of plug outlets 42 are of a size and shape so that they exactly fit inside the face plate openings 2 (holes) as shown in FIG. 1. FIG. 5 shows how the face plate attaches to the outlet receptacle and/or mounting box, with magnets at a location so that they are designed to attach by magnetism at screw holes 41.

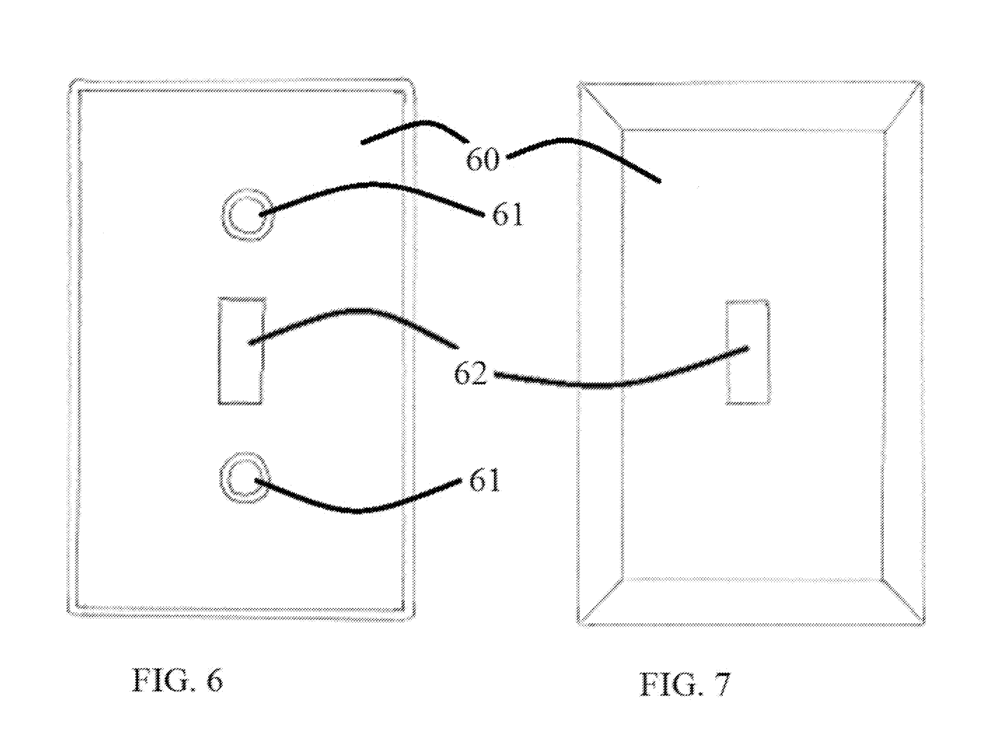

FIG. 6 shows the back side view of a face plate that is designed to fit over a light switch receptacle. The opening 62 in the faceplate is designed to it the light switch. Although the opening 62 in this figure is shown to accommodate a relatively small light switch, it should be understood that the opening 62 can be any of a number of sizes that may be designed to accommodate any light switch (for example, certain dimmer light switches, which may be bigger). The magnets 61 are shown in an alternate position in FIG. 6 that differ from the position of the magnets 1, for example that appear in FIGS. 1, 3, and 5. It should be understood that the magnets 61 can be positioned anywhere as long as they are positioned so that the face plate can be attached by magnetism to the receptacles and/or outlet mounting box.

FIG. 7 shows the front side view of a face plate 60 that is designed to fit over a light switch receptacle and mounting box. It should be noted that the face plate 60 in FIG. 7 only has one opening 62 that is designed to accommodate a light switch. As was discussed above, the opening can be any size to exactly accommodate any light switch. Accordingly, there are no holes necessary for screws giving the face plate 60 a more aesthetic appearance. However, it should be recognized that there are light switch receptacles that may have more than one light switch lever and the face plates should have sufficient openings (holes) to accommodate the various number of light switch levers. Accordingly, the face plate may have two or three or four or more openings.

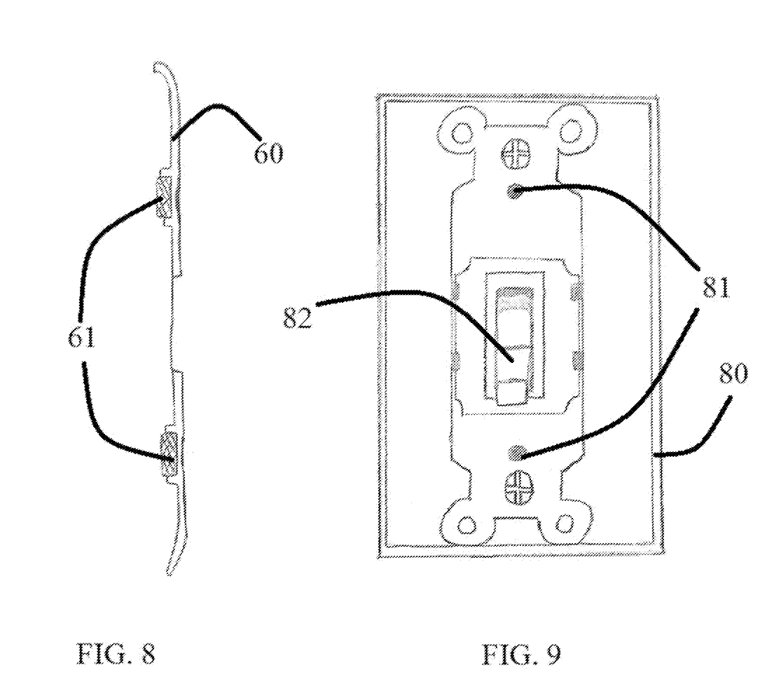

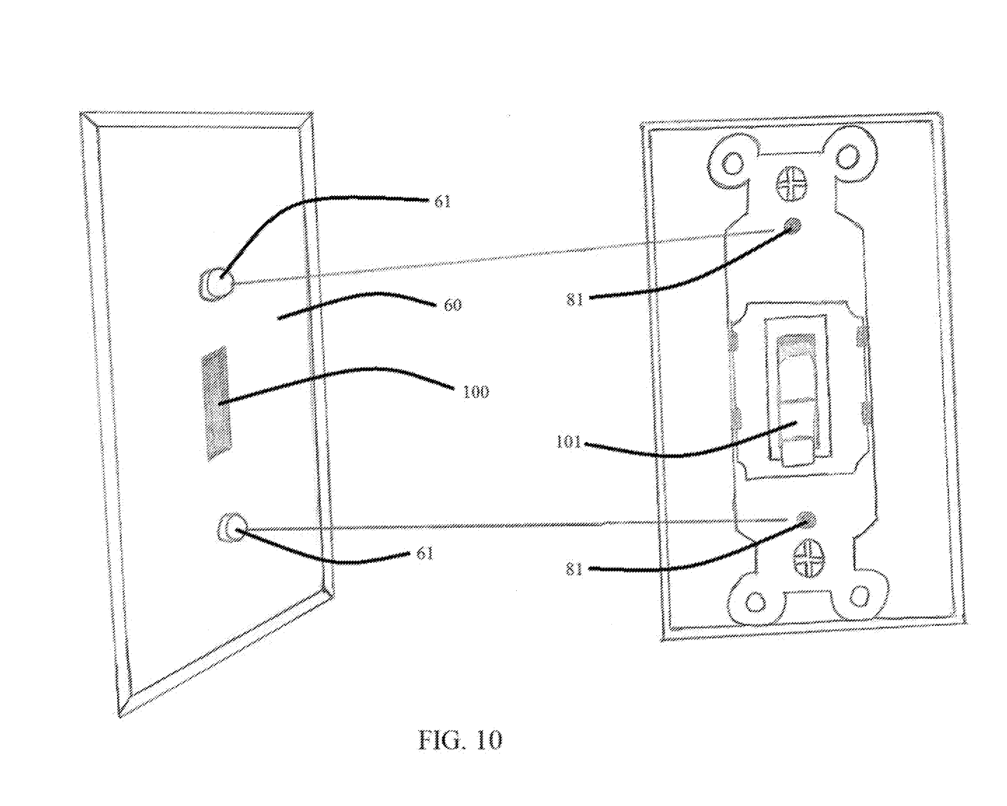

FIG. 8 shows a side view of a face plate 60 that is designed to fit over a light switch receptacle and mounting box. Similarly to FIG. 6, the magnets 61 are positioned differently than the magnets as are shown in, for example, FIG. 1 but it should be understood that the magnets may occur anywhere wherein there is sufficient magnetism that the face plate 60 can attach to the light switch in the outlet mounting box 80 (see FIG. 9). FIG. 9 shows a front view of an electric outlet mounting box containing a light switch receptacle. FIG. 9 shows metal nubs 81 that ma be present on a light switch receptacle that allows the magnets 61 (in FIG. 8) to attach over the light switch receptacle and/or outlet box 80. The light switch lever 82 fits exactly in the opening 62 in the face plate 60 (see FIG. 7). This can better be seen in FIG. 10 wherein the magnets 61 line up with the nubs 81 on the light switch receptacle and the light switch lever 101 fits in the opening 100.

Although the figures of the face plates are shown with usually two magnets, it should be understood that anywhere between one and a plurality of magnets (such as ten magnets) may be used in association with the face plate(s). In one embodiment, the number and strength of magnets should be sufficient so that one gets good solid attachment of the outlet or light switch receptacles with the face plate (e.g., the face plate is not very easily removed).

In one embodiment, the magnets may be of sufficient strength so that metal objects may be attached to the face plate on the outer side of the face plate. For example, a face plate that is close to a front door might have magnets that are of sufficient strength so that keys can be hung up on the outside of the face plate. Accordingly, an individual will be able to easily locate his/her keys when leaving the house.

In a separate embodiment, the magnets may also be attached to the face plate that is used on a junction box wherein there are no holes on the face plate.

The present invention also relates to methods of use of the face plate. In one embodiment, the method includes being able to more quickly secure a face plate relative to a face plate that contains one or more screws as a means of attaching the face plate to an outlet mounting tor junction) box and/or receptacles. This may be particularly advantageous in a commercial setting wherein a large plurality of face plates need to be attached to outlet mounting boxes. In one embodiment, the face plate can be attached to an outlet mounting box in five seconds, or alternatively, in less than five seconds (such as in one second or two seconds or three seconds).

In an embodiment, the present invention relates to a face plate that comprises one or more magnets and at least one opening, said one or more magnets positioned on one side of a face plate wherein said one or more magnets allow said face plate to cover a receptacle and attach to a light switch receptacle or an outlet plug receptacle. In one variation, the one or more magnets are attached by an adhesive.

In one embodiment, the at least one opening is designed to accommodate outlet plugs and/or a light switch.

In one variation, the adhesive is one or more of an epoxy resin, an epoxy putty, an ethylene-vinyl acetate based glue (hot melt glue), a phenol formaldehyde based glue, a polyamide based glue, a polyester resin based adhesive, a polypropylene based glue, a polysulfide based glue, a polyurethane based glue, a polyvinyl acetate based glue, a polyvinyl alcohol based glue, polyvinyl chloride based glue, a polyvinylpyrrolidone based glue, a rubber cement, a silicone based glue, an acrylic copolymer, a styrene acrylic copolymer based glue, a styrene-butadiene-styrene, a styrene-isoprene-styrene, and/or a silicone polymer based glue.

In a variation, the magnets may be integrally molded into the face plate during the manufacture of the face plate.

In an embodiment, the one or more magnets is one or more of Neodymium, Neodymium Iron Boron, Alnico (aluminum, nickel and cobalt alloy), samarium cobalt, or ceramic magnets.

In one variation, the face plate comprises two magnets. The face plate may also comprise three magnets, or four magnets, or five magnets or more.

If the face plate comprises two magnets, in one variation, the two magnets may be positioned on the face plate so that they attach to nubs on a receptacle or screw boles on a receptacle or mounting box.

In one variation, the present invention relates to a face plate that comprises one or more magnets and at least one opening, said one or more magnets positioned on one side of a face plate wherein said one or more magnets allow said face plate to cover a receptacle and attach by magnetism to a light switch receptacle or an outlet plug receptacle, said at least one opening designed to accommodate one or more light switches or outlet plugs; wherein said one or more light switches or outlet plugs are of a same size and shape of the at least one opening so that the one or more light switches or outlet plugs fit snugly in the at least one opening.

In one variation, the one or more magnets is one or more of Neodymium, Neodymium Iron Boron, Alnico (aluminum, nickel and cobalt alloy), samarium cobalt, or ceramic magnets. In a variation, the one or more magnets may be attached by an adhesive.

In one variation, the adhesive is one or more of an epoxy resin, an epoxy putty, an ethylene-vinyl acetate based glue (hot melt glue), a phenol formaldehyde based glue, a polyamide based glue, a polyester resin based adhesive, a polypropylene based glue, a polysulfide based glue, a polyurethane based glue, a polyvinyl acetate based glue, a polyvinyl alcohol based glue, polyvinyl chloride based glue, a polyvinylpyrrolidone based glue, a rubber cement, a silicone based glue, an acrylic copolymer, as styrene acrylic copolymer based glue, a styrene-butadiene-styrene, a styrene-isoprene-styrene, and/or a silicone polymer based glue.

In an alternate embodiment, the one or more magnets may be integrally molded into the face plate during the manufacture of the face plate.

In a variation, the face plate may comprise cavities that are able to accommodate one or more magnets by snap fitting the one or more magnets into the cavities. Usually the number of cavities will be the same as the number of magnets. In one variation, the face plate comprises two magnets and two cavities.

In an embodiment, the present invention relates to a method of attaching a face plate comprising one or more magnets to as light switch receptacle or an outlet receptacle wherein said face plate is attached by magnetism, wherein said faceplate comprises at least one opening that is designed to have a light switch lever or an outlet accessible to a user while the face plate is attached.

In one variation of the method, the at least one opening is designed so that the light switch lever or the outlet fits snugly in the at least one opening. In one variation, the face plate may have two or more openings for two or more light switch levers. Usually, the number of light switch levers will be equal to the number of openings.

In one variation of the method, the face plate is completely attached to the light switch receptacle or the outlet receptacle in less than about five seconds. By completely attached, it is meant that the face plate is securely attached to the receptacle and the face remains in place when left alone.

In one variation of the method, the face plate comprises two magnets.

It should be understood that the present invention is not to be limited by the above description. Modifications can be made to the above without departing from the spirit and scope of the invention. It is contemplated and therefore within the scope of the present invention that any feature that is described above can be combined with any other feature that is described above (even if those features are not described together). Moreover, it should be understood that the present invention contemplates and it is therefore within the scope of the invention that any element that is described can be omitted from the apparatus, product and/or methods of the present invention. In any event, the scope of protection to be afforded is to be determined by the claims which follow and the breadth of interpretation which the law allows.

1) A face plate that comprises two magnets and at least two openings, said two magnets positioned on one side of the face plate wherein said two magnets allow said face plate to cover a receptacle and attach to a light switch receptacle or an outlet plug receptacle.

2) The face plate of claim 1, wherein the two magnets are attached by an adhesive.

3) The face plate of claim 1, wherein the at least two openings are of a size and shape designed to exactly fit outlet plugs or a light switch.

4) The face plate of claim 3, wherein the face plate the at least two openings are designed to exactly fit outlet plugs.

5) The face plate of claim 2, wherein the adhesive is one or more of an epoxy resin, an epoxy putty, an ethylene-vinyl acetate based glue (hot melt glue), a phenol formaldehyde based glue, a polyamide based glue, a polyester resin based adhesive, a polypropylene based glue, a polysulfide based glue, a polyurethane based glue, a polyvinyl acetate based glue, a polyvinyl alcohol based glue, polyvinyl chloride based glue, a polyvinylpyrrolidone based glue, a rubber cement, a silicone based glue, an acrylic copolymer, a styrene acrylic copolymer based glue, a styrene-butadiene-styrene, a styrene-isoprene-styrene, and/or a silicone polymer based glue.

6) The face plate of claim 1, wherein the two magnets are integrally molded into the face plate during the manufacture of the face plate.

7) The face plate of claim 1, wherein the two magnets are one or more of Neodymium, Neodymium Iron Boron, Alnico (aluminum, nickel and cobalt alloy), samarium cobalt, or ceramic magnets.

8) (canceled)

9) The face plate of claim 1, wherein the two magnets are positioned on the face plate so that they attach to nubs or screw holes on the receptacle or mounting box.

10) A face plate that comprises two magnets and at least two openings, said two magnets positioned on one side of the face plate wherein said two magnets allow said face plate to cover a receptacle and attach by magnetism to a light switch receptacle or an outlet plug receptacle, said at least two openings are of a size and shape designed to exactly fit one or more light switches or outlet plugs; wherein said one or more light switches or outlet plugs are of a same size and shape of the at least two openings so that the one or more light switches or outlet plugs fit snugly in the at least two openings.

11) The face plate of claim 10, wherein the two magnets are one or more of Neodymium, Neodymium Iron Boron, Alnico (aluminum, nickel and cobalt alloy), samarium cobalt, or ceramic magnets.

12) The face plate of claim 11, wherein the two magnets are attached by an adhesive.

13) The face plate of claim 12, wherein the adhesive is one or more of an epoxy resin, an epoxy putty, an ethylene-vinyl acetate based glue (hot melt glue), a phenol formaldehyde based glue, a polyamide based glue, a polyester resin based adhesive, a polypropylene based glue, a polysulfide based glue, a polyurethane based glue, a polyvinyl acetate based glue, a polyvinyl alcohol based glue, polyvinyl chloride based glue, a polyvinylpyrrolidone based glue, a rubber cement, a silicone based glue, an acrylic copolymer, a styrene acrylic copolymer based glue, a styrene-butadiene-styrene, a styrene-isoprene-styrene, and/or a silicone polymer based glue.

14) The face plate of claim 11, wherein the two magnets are integrally molded into the face plate during the manufacture of the face plate.

15) The face plate of claim 11, wherein the face plate comprises cavities that are able to accommodate the two magnets by snap fitting the two magnets into the cavities.

16) (canceled)

17) A method of attaching a face plate comprising two magnets to a light switch receptacle or an outlet receptacle wherein said face plate is attached by magnetism, wherein said faceplate comprises at least two openings that are designed to have a light switch lever or an outlet accessible to a user while the face plate is attached.

18) The method of claim 17, wherein the at least two openings are designed so that the light switch lever or the outlet fits snugly in the at least two openings.

19) The method of claim 18, wherein the face plate is completely attached to the light switch receptacle or the outlet receptacle in less than about five seconds.

20) (canceled)
